(19) United States
(12) Patent Application Publication
(10) Pub. No.: US 2015/0201041 A1
(43) Pub. Date: Jul. 16, 2015

(54) DEVICE DEPENDENT CODEC NEGOTIATION

(71) Applicant: GOOGLE INC., Mountain View, CA (US)

(72) Inventor: Zhonglei WANG, Mountain View, CA (US)

(73) Assignee: Google Inc., Mountain View, CA (US)

(21) Appl. No.: 13/846,596

(22) Filed: Mar. 18, 2013

(51) Int. Cl. H04L 29/06

(52) U.S. Cl. CPC H04L 67/42

(57) ABSTRACT

Methods and systems are provided for negotiating codecs between different platforms and devices such that an audio application selects a codec to use based on the capabilities of the platforms and devices. Processing or resource requirements for various combinations of encoders and decoders may be compared against resource thresholds defined for each client. A combination of an encoder and a decoder may be selected for clients wishing to participate in a communication session such that the selected combination is within the resource threshold applicable to each client.

### TECHNICAL FIELD

The present disclosure generally relates to a method for audio processing. More specifically, aspects of the present disclosure relate to selecting an audio codec based on one or more device capabilities.

### BACKGROUND

For various types of messaging and conferencing applications, one of the first steps in establishing communication is building a connection between clients. Codec negotiation is an important part of this process.

Many existing approaches to codec negotiation between clients are based on the particular codec that is built into software or on a pre-defined static codec list. Under such approaches, the messaging or conferencing application does not consider whether the codec is capable of running on the particular devices being utilized at the clients. For example, while a mobile platform and a desktop platform may share similar software base code, just because a given codec configuration can run on a desktop device does not necessarily mean that same configuration can also run on a mobile device (due to, for example, CPU limitations, system resource limitations, etc.).

### SUMMARY

This Summary introduces a selection of concepts in a simplified form in order to provide a basic understanding of some aspects of the present disclosure. This Summary is not an extensive overview of the disclosure, and is not intended to identify key or critical elements of the disclosure or to delineate the scope of the disclosure. This Summary merely presents some of the concepts of the disclosure as a prelude to the Detailed Description provided below.

One embodiment of the present disclosure relates to a computer-implemented method for negotiating an audio codec between clients, the method comprising: defining a resource threshold for audio processing for a first client; detecting one or more parameters of a device being used at the first client; receiving information about a combination of an encoder and a decoder selected for a second client; determining whether resource requirements of the combination of the encoder and the decoder selected for the second client exceed the resource threshold defined for the first client; and in response to determining that the resource requirements of the combination of the encoder and the decoder selected for the second client exceed the resource threshold defined for the first client, selecting a new combination of an encoder and a decoder for the first client, the new combination of the encoder and the decoder having resource requirements within the resource threshold defined for the first client.

In another embodiment, the method for negotiating an audio codec further comprises sending from the first client to the second client information about the new combination of the encoder and the decoder selected for the first client.

In another embodiment, the method for negotiating an audio codec further comprises, in response to determining that the resource requirements of the combination of the encoder and the decoder selected for the second client are within the resource threshold defined for the first client, sending from the first client to the second client an acknowledgement of the combination of the encoder and the decoder selected for the second client.

In another embodiment, the method for negotiating an audio codec further comprises comparing the combination of the encoder and the decoder selected for the second client with the resource threshold defined for the first client.

In yet another embodiment, the method for negotiating an audio codec further comprises generating, for the first client, an encoder table and a decoder table, the encoder table identifying a plurality of encoders available for encoding audio data at the first client and the decoder table identifying a plurality of decoders available for decoding audio data at the first client.

In still another embodiment, the method for negotiating an audio codec further comprises assigning priority levels to the encoders and decoders identified in the respective encoder table and decoder table, the priority levels being assigned based on quality of audio associated with each of the encoders and decoders.

In another embodiment of the method for negotiating an audio codec, the step of selecting the new combination of the encoder and the decoder for the first client includes: selecting an encoder from the plurality of encoders identified in the encoder table based on the one or more parameters of the device being used at the first client; and selecting a decoder from the plurality of decoders identified in the decoder table based on the one or more parameters of the device being used at the first client.

According to one or more other embodiments of the present disclosure, the methods presented herein may optionally include one or more of the following additional features: the selection of the new combination of the encoder and the decoder for the first client is based on the one or more parameters of the device being used at the first client; the resource threshold for audio processing is defined by an audio application running on the device being used at the first client; the resource threshold for audio processing is an amount of CPU available for audio processing at the first client; the one or more parameters of the device being used at the first client include one or both of available CPU and available memory; the encoder table contains information about resource requirements for each of the plurality of encoders, the resource requirements for each of the encoders being particular to the device being used at the first client; the decoder table contains information about resource requirements for each of the plurality of decoders, the resource requirements for each of the encoders being particular to the device being used at the first client; the encoder is selected from the encoder table according to a lowest priority assigned; and/or the decoder is selected from the decoder table according to a lowest priority assigned.

Further scope of applicability of the present disclosure will become apparent from the Detailed Description given below. However, it should be understood that the Detailed Description and specific examples, while indicating preferred embodiments, are given by way of illustration only, since various changes and modifications within the spirit and scope of the disclosure will become apparent to those skilled in the art from this Detailed Description.

### BRIEF DESCRIPTION OF DRAWINGS

These and other objects, features and characteristics of the present disclosure will become more apparent to those skilled in the art from a study of the following Detailed Description in conjunction with the appended claims and drawings, all of which form a part of this specification. In the drawings:

FIG. 1 is a data flow diagram illustrating an example codec negotiation between clients.

FIG. 2A illustrates an example table containing information about priorities and complexities of decoders according to one or more embodiments described herein.

FIG. 2B illustrates an example table containing information about priorities and complexities of encoders according to one or more embodiments described herein.

FIG. 3 is a flowchart illustrating an example method for determining available resources and capabilities of a device/platform and selecting a codec based on the available resources and capabilities according to one or more embodiments described herein.

FIG. 4 is a flowchart illustrating an example method for selecting a codec based on available device resources according to one or more embodiments described herein.

FIG. 5 is a flowchart illustrating an example method for evaluating a proposed codec based on available device resources according to one or more embodiments described herein.

FIG. 6 is a block diagram illustrating an example computing device arranged for selecting a codec based on available device resources according to one or more embodiments described herein.

The headings provided herein are for convenience only and do not necessarily affect the scope or meaning of the claims.

In the drawings, the same reference numerals and any acronyms identify elements or acts with the same or similar structure or functionality for ease of understanding and convenience. The drawings will be described in detail in the course of the following Detailed Description.

### DETAILED DESCRIPTION

Various examples and embodiments will now be described. The following description provides specific details for a thorough understanding and enabling description of these examples. One skilled in the relevant art will understand, however, that the embodiments described herein may be practiced without many of these details. Likewise, one skilled in the relevant art will also understand that these embodiments can include many other obvious features not described in detail herein. Additionally, some well-known structures or functions may not be shown or described in detail below, so as to avoid unnecessarily obscuring the relevant description.

Embodiments of the present disclosure relate to methods for negotiating codecs between different platforms and devices such that an audio application (e.g., a messaging application, conferencing application, etc.) selects a codec to use based on the capabilities of the platforms and devices. As will be further described below, the methods presented herein may be expanded or adjusted to accommodate changes in device/platform characteristics and/or in codec availability without the need to change the underlying algorithm. Additionally, the methods described may be integrated into one or more existing codec negotiation processes, and may be used in conjunction with any of a variety of peer-to-peer communication or conferencing applications.

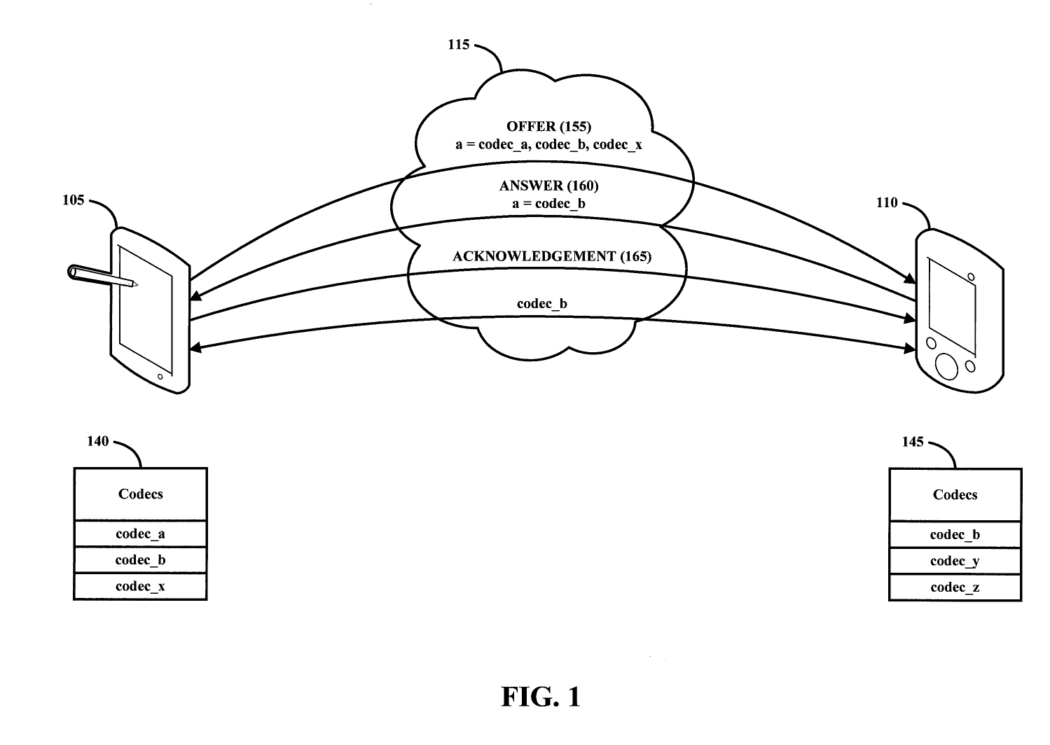

FIG. 1 illustrates an example of a typical codec negotiation (e.g., selection) data flow between clients. For example, client 105 may initiate a communication session over a network 115 with client 110 by sending an offer 155 to client 110, where the offer 155 may identify codec_a, codec_b, codec_x as possible codecs that can be used by the clients during the communication session. Client 110 may respond to the offer 155 by sending an answer 160 back to client 105, where the answer 160 may identify codec_b as the codec to be used by clients 105 and 110. Client 105 may send to client 110 an acknowledgement 165 of the selection of codec_b. Once the selection of codec_b has been acknowledged 165, clients 105 and 110 may continue with additional steps in establishing a communication session.

Existing approaches to codec negotiation between clients are typically based on the particular codec built into the relevant software or contained in a pre-defined static codec list. For example, the codec negotiation between client 105 and client 110 may proceed according to codec lists 140 and 145, respectively. While codec list 140 includes codec_a, codec_b, and codec_x, codec list 145 includes codec_b, codec_y, and codec_z. Accordingly, the answer 160 sent by client 110 to client 105, in response to the offer 155 made by client 105, identifies the codec common to both clients (e.g., codec_b) as the selected codec.

As discussed above, during codec negotiation with such existing approaches, the messaging or conferencing application does not account for whether the codec is capable of running on the particular platform or devices being utilized at the clients. For example, there may be certain limitations (e.g., CPU, system resources, etc.) that exist for a mobile device that do not exist (or are at least different from the limitations) for a desktop device. Therefore, a particular codec configuration that is capable of running on a desktop device may not be capable of also running on a mobile device. For example, consider the three audio codecs OPUS, iSAC (internet Speech Audio Codec), and G.711. Due to the complexity of these codecs, an audio application is likely not able to run the same codec across all mobile platforms that may be participating in a communication session.

In accordance with at least one embodiment described herein, CPU and/or memory may be factors that are considered by an application when selecting codecs for a communication session between clients. A given codec, such as OPUS for example, requires different CPU powers across different devices (e.g., OPUS requires higher CPU when executing on ARMv7 than when executing on ARMv5). Also, different codecs require different amounts of CPU on similar devices. For example, OPUS generally requires more CPU than G.711 on any given platform (e.g., ARMv5, ARMv7, etc.). Similar reasoning may be applied to memory requirements for different codec across different devices/platforms.

Session Initiation Protocol (SIP) is an IETF-defined signaling protocol widely used for controlling communication sessions such as voice and video calls over Internet Protocol (IP). Also, Session Description Protocol (SDP) is a format for describing streaming media initialization parameters. However, neither these nor other existing protocols take into consideration device information, capabilities, etc.

As will be described in greater detail below, the present disclosure provides a method for negotiating an audio codec between multiple devices based on device capabilities.

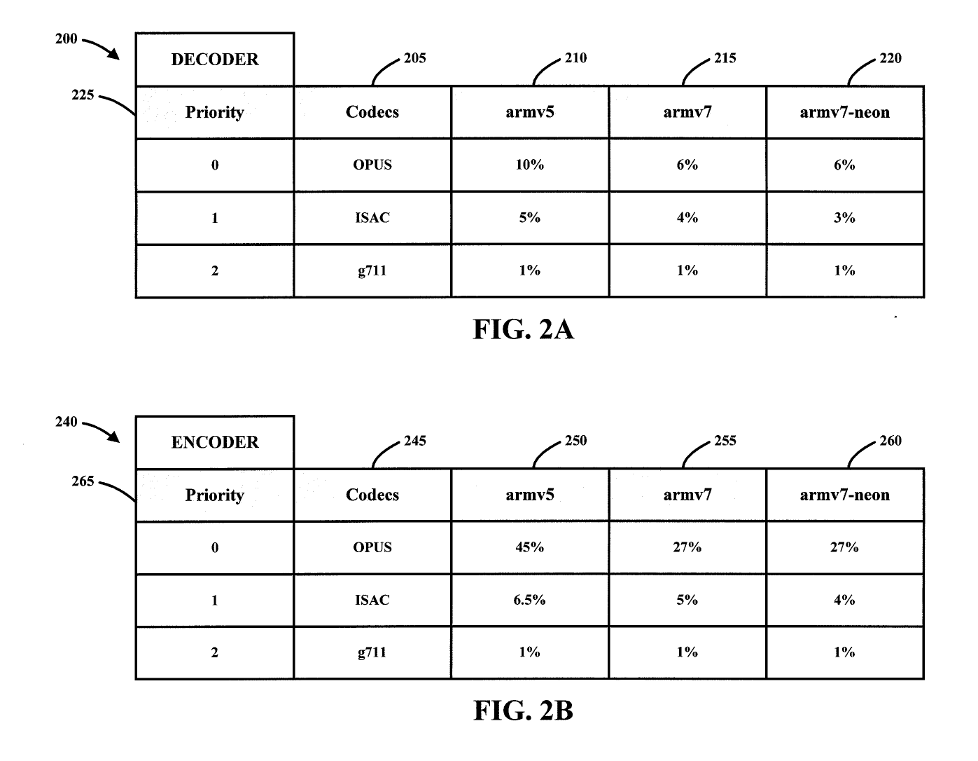

FIGS. 2A and 2B are examples of tables containing data and information about various audio codecs and their complexities on different platforms. In accordance with one or more embodiments described herein, such tables may be compiled and utilized (e.g., by an audio application) to select a codec for a communication session between clients based on the capabilities of the platforms or devices being used at the clients (e.g., the platforms or devices on which the application is running). Table 200 includes information that may be used in negotiating a decoder between clients (e.g., clients 105 and 110 as shown in FIG. 1) while table 240 includes information that may be used in negotiating an encoder. It should be understood that the information presented in tables 200 and 240 is purely illustrative in nature, and is not in any way intended to limit the scope of the present disclosure.

Tables 200 and 240 may include information associated with a number of audio codecs (columns 205, 245) that may be used for encoding and decoding audio data at the clients (e.g., clients 105 and 110 as shown in FIG. 1). While tables 200 and 240 include information associated with OPUS, iSAC, and G.711, it should be appreciated that numerous other codecs may also be included in either or both of tables 200 and 240, in addition to or instead of these example codecs. Each of the codecs (205, 245) may be assigned a priority (225, 265) that determines an order in which the codecs may be selected during codec negotiation. In accordance with at least one embodiment, priorities (225, 265) may be assigned to the codecs (205, 245) based on audio application preference. For example, the priorities (225, 265) may be decided according to audio quality, where OPUS is a super wideband codec, iSAC is a wide band codec, and G.711 is a narrow band codec.

According to at least one embodiment, tables 200 and 240 may also contain information about the complexities of each of the codecs (205, 245) on different platforms or devices. For example, tables 200 and 240 may include, for each of the codecs (205, 245), CPU complexities (e.g., percentage (%) of CPU required) on such processors as ARMv5 (210, 250), ARMv7 (215, 255), and ARMv7-NEON (220, 260). It should be understood that various other platforms and/or devices may also be provided for in one or both of tables 200 and 240 in addition to or instead of the example platforms/devices shown.

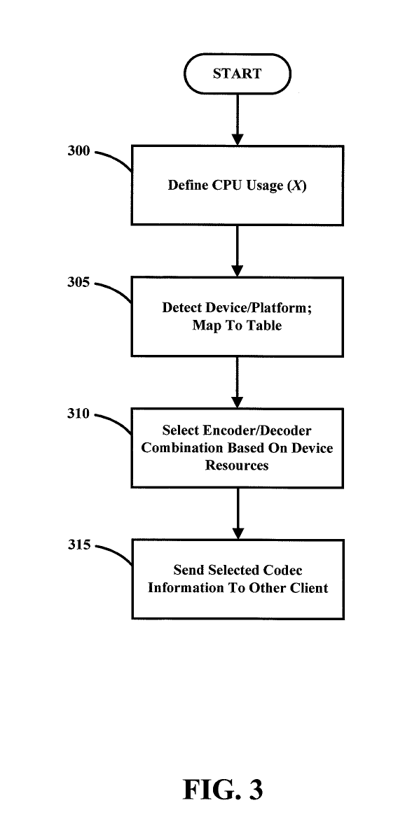

FIGS. 3-5 illustrate example processes for selecting a codec based on the clients' available device resources or device capabilities. As will be further described below, according to one or more embodiments described herein, a caller (e.g., client 105 as shown in the example of FIG. 1) may select an encoder and decoder combination (e.g., configuration) based on the resources or capabilities of the particular device/platform being used by the caller. The caller may then send the selected combination of encoder and decoder to the callee (e.g., client 110 as shown in the example of FIG. 1). The callee may use the information about the configuration received from the caller, as well as the resources/capabilities of the particular device or platform being used by the callee, to select its own combination of encoder and decoder that the callee then sends back to the caller. Once a codec configuration is agreed upon at the clients, the data communication session may begin.

FIG. 3 illustrates an example process for determining available resources and capabilities of a device/platform being used by client and selecting an audio codec based on the available resources and capabilities. In accordance with one or more embodiments described herein, the process may be performed by an audio application when establishing a data communication session between clients (e.g., clients 105 and 110 as shown in FIG. 1). It should be noted that the operations described below with respect to blocks 300 through 315 may be performed by an application running at any or all clients participating in a communication session.

At block 300, the application may define a resource threshold (e.g., a maximum percentage of available CPU) for an audio codec used at the client. For example, the application may define that audio processing at the client will use up to “X” percent of total CPU (where “X” is an arbitrary number). At block 305, the application may detect various parameters (e.g., specifications, resources, capabilities, etc.) for the device/platform that the application is running on at the client.

At block 310, the application may loop through corresponding decoder and encoder tables (e.g., tables 200 and 240 as shown in FIGS. 2A and 2B, respectively) compiled for the client and select a combination of an encoder and decoder based on the detected parameters for the device/platform. For example, the application may evaluate the possible encoder/decoder entries contained in the tables according to the order of priorities assigned to the various codecs (e.g., priority levels assigned in columns 225 and 265 of tables 200 and 240, respectively). For example, the encoder/decoder options included in the tables may be evaluated from high priority to low priority when selecting a combination at block 310 (where, for example, “0” is the highest priority). At block 315, the selected combination of encoder/decoder may be sent to the other client participating in the communication session.

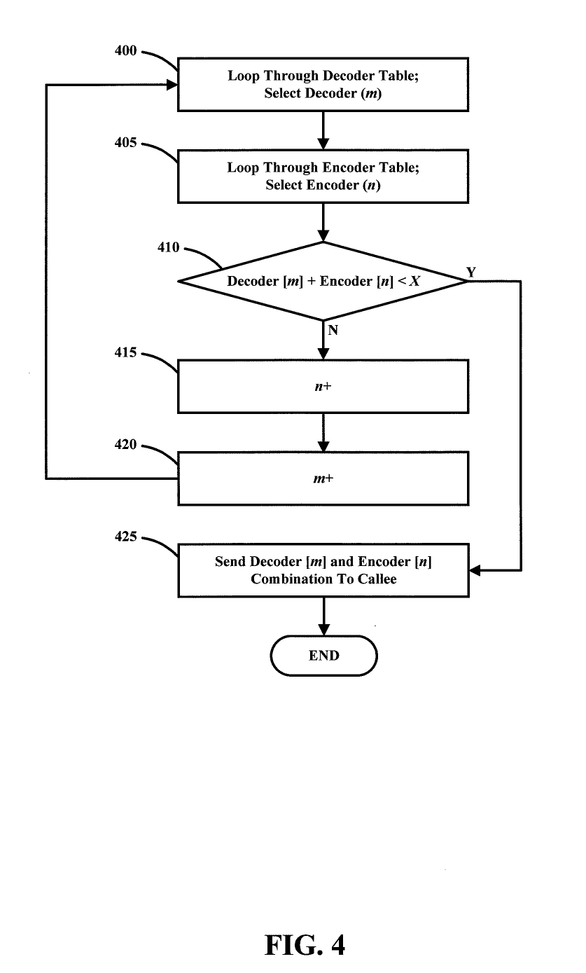

FIG. 4 illustrates an example process for selecting a combination of an audio decoder and encoder for use during a communication session between clients. In accordance with at least one embodiment described herein, the process may be performed by an audio application running at a client that initiates the communication session with another client (e.g., client 105 initiating a communication session with client 110, as shown in the example of FIG. 1).

At block 400, the process may loop through a decoder table (e.g., table 200 as shown in FIG. 2A) for the client and select a decoder (m). For example, the application may evaluate the information included in the decoder table for each of the decoders from high priority to low priority in order to make a selection of a decoder. At block 405, the process may loop through a corresponding encoder table for the client and select an encoder (n). In accordance with at least one embodiment, the selections of the decoder and encoder at blocks 400 and 405, respectively, may be based on characteristics (e.g., available resources, capabilities, etc.) of the particular device/platform that the audio application is running on.

At block 410, a determination may be made as to whether the resource requirements of the selected combination of decoder (m) and encoder (n) are within (e.g., do not exceed) a resource threshold defined for the client (e.g., resource threshold “X” as defined at block 300 of the process shown in FIG. 3). For example, it may be determined whether the combined CPU complexities associated with the selected decoder and encoder are under a CPU threshold amount set for the particular device/platform being used at the client. If the resource requirements of the selected combination are within the resource threshold, then at block 425 the selected combination of decoder (m) and encoder (n) may be sent to the other client (e.g., the callee) participating in the communication session.

On the other hand, if it is determined at block 410 that the resource requirements of the selected combination of decoder (m) and encoder (n) are not within the resource threshold, then at block 415 a priority count for the encoder may be increased and at block 420 a priority count for the decoder may be increased. It should be noted that increasing the priority counts for each of the encoder and decoder may advance the evaluation/selection to a new encoder and decoder within the corresponding encoder and decoder tables for the client (e.g., tables 200 and 240 as shown in FIGS. 2A and 2B). The process may then return to blocks 400 and 405 where a different decoder and encoder combination may be selected.

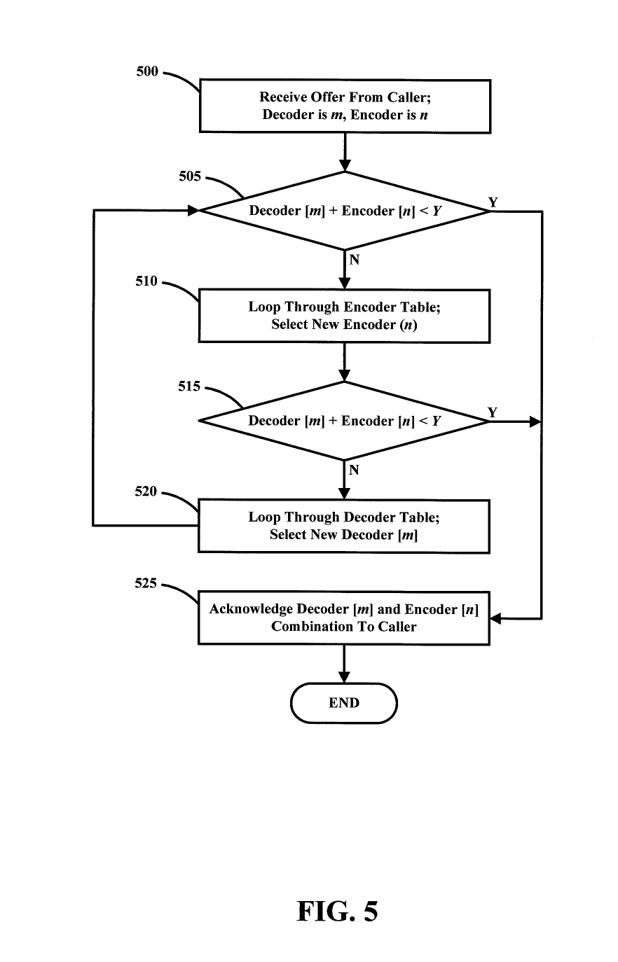

FIG. 5 illustrates an example process for evaluating a proposed combination of an audio decoder and encoder for use during a communication session between clients. In accordance with at least one embodiment described herein, the process may be performed by an audio application running at a client that receives a request to establish the communication session from another client (e.g., client 110 receiving the initiating communication from client 105, as shown in the example of FIG. 1).

At block 500, a client (e.g., client 110) may receive an offer to connect from another client wishing to establish a communication session. For purposes of the following description, the client at which the offer is received may be referred to as the “receiving client” while the client from which the offer is sent may be referred to as the “sending client,” for purposes of clarity. The offer received at the receiving client may include information indicating a combination of an encoder and a decoder selected by the sending client for use in transmitting audio during the communication session. For example, the receiving client may receive information indicating that the sending client has selected a combination of decoder m and encoder n.

At block 505, the selected combination of decoder m and encoder n may be compared against a resource threshold (Y) defined for the receiving client (e.g., resource threshold “X” as defined at block 300 of the process shown in FIG. 3, which may be the same as or different from the resource threshold Y). For example, at block 505, a determination may be made as to whether the resource requirements of the selected combination of decoder (m) and encoder (n) received from the sending client are within (e.g., do not exceed) the resource threshold (which in this example is represented as resource threshold “Y”) defined for the receiving client. For example, it may be determined whether the combined CPU complexities associated with the decoder and encoder selected for the sending client are under a CPU threshold amount set for the particular device/platform being used at the receiving client. If the resource requirements of the combination selected for the sending client are within the resource threshold defined for the receiving client, then at block 525 the selected combination of decoder (m) and encoder (n) may be acknowledged to the sending client.

On the other hand, if it is determined at block 505 that the resource requirements of the selected combination of decoder (m) and encoder (n) from the sending client are not within the resource threshold defined for the receiving client, then at block 510 the process may loop through an encoder table (e.g., table 240 as shown in FIG. 2A) for the receiving client and select a new encoder (n). For example, the application may evaluate the information included in the encoder table for each of the encoders from high priority to low priority in order to make a selection of a new encoder to use during the communication session with the sending client.

At block 515, the new combination of decoder m and encoder n selected for the receiving client may be compared against the resource threshold defined for the receiving client. Similar to the comparison that may be made at block 505, described above, the comparison at block 515 may be made to determine whether the resource requirements of the new combination of decoder (m) and encoder (n) selected for the receiving client are within (e.g., do not exceed) the resource threshold defined for the receiving client.

If it is determined at block 515 that the resource requirements of the new combination of decoder (m) and encoder (n) selected for the receiving client are not within the resource threshold defined for the receiving client, then at block 520 the process may loop through a corresponding decoder table for the receiving client and select a new decoder (m). In accordance with at least one embodiment, the selections of a new encoder and decoder at blocks 510 and 520, respectively, may be based on characteristics (e.g., available resources, capabilities, etc.) of the particular device/platform that the audio application is running on at the receiving client.

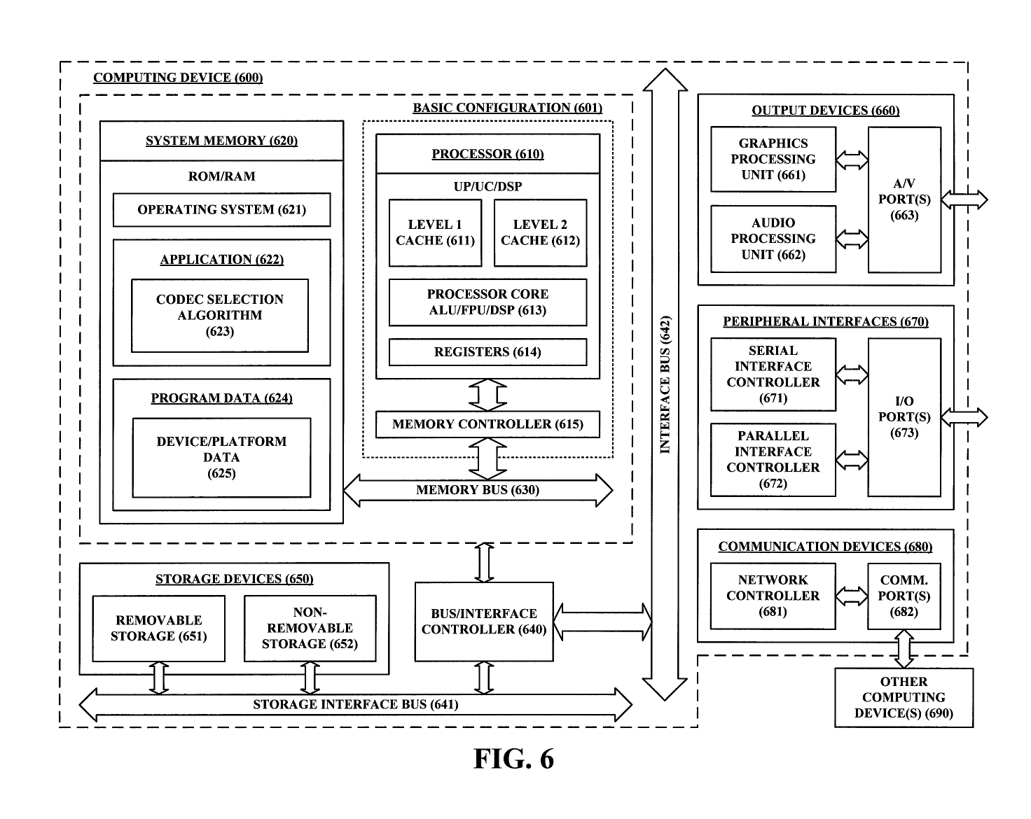

FIG. 6 is a block diagram illustrating an example computing device 600 that is arranged for determining audio latencies in audio capture and audio playout processes based on calculated time differences for interrupt events in accordance with one or more embodiments of the present disclosure. In a very basic configuration 601, computing device 600 typically includes one or more processors 610 and system memory 620. A memory bus 630 may be used for communicating between the processor 610 and the system memory 620.

Depending on the desired configuration, processor 610 can be of any type including but not limited to a microprocessor (μP), a microcontroller (μC), a digital signal processor (DSP), or any combination thereof. Processor 610 may include one or more levels of caching, such as a level one cache 611 and a level two cache 612, a processor core 613, and registers 614. The processor core 613 may include an arithmetic logic unit (ALU), a floating point unit (FPU), a digital signal processing core (DSP Core), or any combination thereof. A memory controller 615 can also be used with the processor 610, or in some embodiments the memory controller 615 can be an internal part of the processor 610.

Depending on the desired configuration, the system memory 620 can be of any type including but not limited to volatile memory (e.g., RAM), non-volatile memory (e.g., ROM, flash memory, etc.) or any combination thereof. System memory 620 typically includes an operating system 621, one or more applications 622, and program data 624. In at least some embodiments, application 622 includes a codec selection algorithm 623 that is configured to select an encoder and decoder combination for a client (e.g., client 105 as shown in the example of FIG. 1) based on the resources and capabilities of the particular device/platform being used by the client. The codec selection algorithm 623 is further arranged to provide the selected combination of encoder and decoder to a second client (e.g., client 110 as shown in FIG. 1) when initiating a communication session with the second client.

Program Data 624 may include device/platform data 625 that is useful for determining which of a plurality of audio codecs may be compatible with a particular device or platform being used by a client in a communication session. In some embodiments, application 622 can be arranged to operate with program data 624 on an operating system 621 such that device/platform data 625 may be utilized by the codec selection algorithm 623 to negotiate an audio codec between clients when establishing a communication session.

Computing device 600 can have additional features and/or functionality, and additional interfaces to facilitate communications between the basic configuration 601 and any required devices and interfaces. For example, a bus/interface controller 640 can be used to facilitate communications between the basic configuration 601 and one or more data storage devices 650 via a storage interface bus 641. The data storage devices 650 can be removable storage devices 651, non-removable storage devices 652, or any combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), tape drives and the like. Example computer storage media can include volatile and nonvolatile, removable and non-removable media implemented in any method or technology for storage of information, such as computer readable instructions, data structures, program modules, and/or other data.

System memory 620, removable storage 651 and non-removable storage 652 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 600. Any such computer storage media can be part of computing device 600.

Computing device 600 can also include an interface bus 642 for facilitating communication from various interface devices (e.g., output interfaces, peripheral interfaces, communication interfaces, etc.) to the basic configuration 601 via the bus/interface controller 640. Example output devices 660 include a graphics processing unit 661 and an audio processing unit 662, either or both of which can be configured to communicate to various external devices such as a display or speakers via one or more A/V ports 663. Example peripheral interfaces 670 include a serial interface controller 671 or a parallel interface controller 672, which can be configured to communicate with external devices such as input devices (e.g., keyboard, mouse, pen, voice input device, touch input device, etc.) or other peripheral devices (e.g., printer, scanner, etc.) via one or more I/O ports 673.

An example communication device 680 includes a network controller 681, which can be arranged to facilitate communications with one or more other computing devices 690 over a network communication (not shown) via one or more communication ports 682. The communication connection is one example of a communication media. Communication media may typically be embodied by computer readable instructions, data structures, program modules, or other data in a modulated data signal, such as a carrier wave or other transport mechanism, and includes any information delivery media. A “modulated data signal” can be a signal that has one or more of its characteristics set or changed in such a manner as to encode information in the signal. By way of example, and not limitation, communication media can include wired media such as a wired network or direct-wired connection, and wireless media such as acoustic, radio frequency (RF), infrared (IR) and other wireless media. The term computer readable media as used herein can include both storage media and communication media.

Computing device 600 can be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 600 can also be implemented as a personal computer including both laptop computer and non-laptop computer configurations.

There is little distinction left between hardware and software implementations of aspects of systems; the use of hardware or software is generally (but not always, in that in certain contexts the choice between hardware and software can become significant) a design choice representing cost versus efficiency trade-offs. There are various vehicles by which processes and/or systems and/or other technologies described herein can be effected (e.g., hardware, software, and/or firmware), and the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation. In one or more other scenarios, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those skilled within the art that each function and/or operation within such block diagrams, flowcharts, or examples can be implemented, individually and/or collectively, by a wide range of hardware, software, firmware, or virtually any combination thereof.

In one or more embodiments, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments described herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof. Those skilled in the art will further recognize that designing the circuitry and/or writing the code for the software and/or firmware would be well within the skill of one of skilled in the art in light of the present disclosure.

Additionally, those skilled in the art will appreciate that the mechanisms of the subject matter described herein are capable of being distributed as a program product in a variety of forms, and that an illustrative embodiment of the subject matter described herein applies regardless of the particular type of signal-bearing medium used to actually carry out the distribution. Examples of a signal-bearing medium include, but are not limited to, the following: a recordable-type medium such as a floppy disk, a hard disk drive, a Compact Disc (CD), a Digital Video Disk (DVD), a digital tape, a computer memory, etc.; and a transmission-type medium such as a digital and/or an analog communication medium (e.g., a fiber optic cable, a waveguide, a wired communications link, a wireless communication link, etc.).

Those skilled in the art will also recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

I claim:

1. A computer-implemented method for negotiating an audio codec between clients, the method comprising:
defining a resource threshold for audio processing for a first client;
detecting one or more parameters of a device being used at the first client;
receiving information about a combination of an encoder and a decoder selected for a second client;
determining whether resource requirements of the combination of the encoder and the decoder selected for the second client exceed the resource threshold defined for the first client; and
responsive to determining that the resource requirements of the combination of the encoder and the decoder selected for the second client exceed the resource threshold defined for the first client, selecting a new combination of an encoder and a decoder for the first client, the new combination of the encoder and the decoder having resource requirements within the resource threshold defined for the first client.

2. The method of claim 1, further comprising sending from the first client to the second client information about the new combination of the encoder and the decoder selected for the first client.

3. The method of claim 1, further comprising, responsive to determining that the resource requirements of the combination of the encoder and the decoder selected for the second client are within the resource threshold defined for the first client, sending from the first client to the second client an acknowledgement of the combination of the encoder and the decoder selected for the second client.

4. The method of claim 1, further comprising comparing the combination of the encoder and the decoder selected for the second client with the resource threshold defined for the first client.

5. The method of claim 1, wherein the selection of the new combination of the encoder and the decoder for the first client is based on the one or more parameters of the device being used at the first client.

6. The method of claim 1, wherein the resource threshold for audio processing is defined by an audio application running on the device being used at the first client.

7. The method of claim 1, wherein the resource threshold for audio processing is an amount of CPU available for audio processing at the first client.

8. The method of claim 1, wherein the one or more parameters of the device being used at the first client include one or both of available CPU and available memory.

9. The method of claim 1, further comprising generating, for the first client, an encoder table and a decoder table, the encoder table identifying a plurality of encoders available for encoding audio data at the first client and the decoder table identifying a plurality of decoders available for decoding audio data at the first client.

10. The method of claim 9, wherein the encoder table contains information about resource requirements for each of the plurality of encoders, the resource requirements for each of the encoders being particular to the device being used at the first client.

11. The method of claim 9, wherein the decoder table contains information about resource requirements for each of the plurality of decoders, the resource requirements for each of the encoders being particular to the device being used at the first client.

12. The method of claim 9, further comprising assigning priority levels to the encoders and decoders identified in the respective encoder table and decoder table, the priority levels being assigned based on quality of audio associated with each of the encoders and decoders.

13. The method of claim 9, wherein the selection of the new combination of the encoder and the decoder for the first client includes:
selecting an encoder from the plurality of encoders identified in the encoder table based on the one or more parameters of the device being used at the first client; and
selecting a decoder from the plurality of decoders identified in the decoder table based on the one or more parameters of the device being used at the first client.

14. The method of claim 13, wherein the encoder is selected from the encoder table according to a lowest priority assigned.

15. The method of claim 13, wherein the decoder is selected from the decoder table according to a lowest priority assigned.
